(19) United States
(12) Patent Application Publication
(10) Pub. No.: US 2016/0187640 A1
(43) Pub. Date: Jun. 30, 2016

(54) Optically Correcting Configuration for a Reflector Telescope

(71) Applicant: Gaston Daniel Baudat, Glenmoore, PA (US)

(72) Inventor: Gaston Daniel Baudat, Glenmoore, PA (US)

(21) Appl. No.: 14/986,558

(22) Filed: Dec. 31, 2015

Related U.S. Application Data
(60) Provisional application No. 62/098,373, filed on Dec. 31, 2014.

(51) Int. Cl. G02B 23/16; G02B 23/06; G02B 27/40; G02B 27/14; G02B 7/182; G02B 23/04; G02B 27/10

(52) U.S. Cl. CPC G02B 23/16; G02B 23/04; G02B 23/06; G02B 27/1006; G02B 27/142; G02B 27/144; G02B 7/1821; G02B 7/1827; G02B 27/40

(57) ABSTRACT

An optically correcting configuration for a reflector telescope allows the reflector telescope to implement an auto-guiding system and an auto-focusing system without interrupting the regular capture of incoming light. The auto-guiding system and/or the auto-focusing system are in optical communication with a secondary optical output. The reflector telescope allows incoming light to travel towards a collecting mirror, from the collecting mirror to a redirecting mirror, and from the redirecting mirror to a primary optical output. A portion of the incoming light travels to the secondary optical output through an optical diverting feature of the redirecting mirror and is used in the analysis for the auto-guiding system and/or the auto-focusing system. Consequently, the redirecting mirror is positioned in between the primary optical output and the secondary optical output.

The current application claims a priority to the U.S. Provisional Patent application Ser. No. 62/098,373 filed on Dec. 31, 2014.

### FIELD OF THE INVENTION

The present invention relates generally to a reflector telescope. More specifically, the present invention allows for the auto-guiding system and auto-focusing system to be configured into the reflector telescope.

### BACKGROUND OF THE INVENTION

Reflector telescopes are typically made with two mirrors. The primary mirror (M1) reflects the incoming light to a secondary mirror (M2). M1 typically defines the aperture and pupil of the reflector telescope.

M1 has a positive magnification power (concave mirror), while the M2 has an optical magnification power that is usually zero (flat mirror like for Newtonian telescopes) or negative (convex mirror), which is known as the Cassegrain configuration. When both mirrors share the same optical axis, the light reflected by M2 goes back through a central hole in M1, we have a symmetrical Cassegrain telescope. The symmetrical Cassegrain telescope layout is a very popular design that provides a long focal length in a compact format. The optical tube assembly (OTA) length is generally much smaller than the actual telescope focal length. The Schmidt-Cassegrain telescopes, Ritchey-Chretien telescopes, Maksutov-Cassegrain telescope, among many others, are members of the symmetrical Cassegrain family of telescopes.

Newtonian telescopes are also very popular reflector. Newtonian telescopes use a parabolic mirror for M1 and a flat mirror for M2. However, the focal plane is usually placed off axis, at 90 degree, from the OTA and optical axes. A M2 flat mirror leads to a long OTA since its optical power is zero, the OTA is typically almost as long as the telescope focal length.

Like for any imaging system, focus must be achieved for good quality images. Since the targets of interest (galaxy, nebula, star field, etc.) are far away from the telescopes relative to the focal length, the image forms at the telescope focal plane. With large focal lengths it is critical that the imaging camera is placed at, or very near to, the focal plane. The depth of focus (DOF) could be as little as +/−4 microns for a F/3 system. Table 1 shows the depth of focus DOF for various F/# assuming a λ/3 and λ/10 defocus wave front error.

TABLE 1
Depth of focus vs. F/# and defocus wave front error

| | F/# | | | |
|---|---|---|---|---|
| λ = 550 NM | F/3 | F/6 | F/8 | F/10 |
| FOCUS | +/−4 μm | +/−16 μm | +/−28 μm | +/−44 μm |
| ERROR | | | | |
| λ/10 | | | | |
| FOCUS | +/−12 μm | +/−48 μm | +/−86 μm | +/−134 μm |
| ERROR | | | | |
| λ/3 | | | | |

To reach such tight DOF values, the OTA and related optical train (camera, filter wheel, focuser, etc.) need to be flexure free and temperature compensated, which could be a very expensive proposition, or the focus must be periodically adjusted. Temperature usually drops over the time of imaging a target which would likely impact the focus enough to require refocusing at least in a periodic basis.

When imaging deep space objects, hours of total exposure are necessary to produce a good quality image. Typically, sub-frames of shorter exposure times are used, about 15 to 30 minutes long, then registered and stacked by a computer. During a single frame, the focus must remain inside the DOF, and the object must remain still. The former requirement implies some type of real time auto-focus mechanism, or shorter exposures for periodic re-focusing, the later requirement calls for an auto-guiding strategy to compensate for likely flexure, atmospheric refractions and other sources of drift. Therefore, an objective of the present invention is to combine real auto-focus and auto-guiding techniques into one device.

### BRIEF DESCRIPTION OF THE DRAWINGS

FIG. 1 is a schematic view of the Cassegrain configuration for a reflector telescope, wherein the optically diverting feature is a hole through the redirecting mirror.

FIG. 2 is a schematic view of the Cassegrain configuration for a reflector telescope, wherein the optically diverting feature is a hole through just the reflective surface of the redirecting mirror.

FIG. 3 is a schematic view of the Cassegrain configuration for a reflector telescope, wherein the optically diverting feature is a wavelength-based beam splitting coating.

FIG. 4 is a schematic view of the Cassegrain configuration for a reflector telescope, wherein the optically diverting feature is an energy-based beam splitting coating.

FIG. 5 is a schematic view of the Cassegrain configuration for a reflector telescope, wherein the secondary optical output is optical communication with the auto-guiding system.

FIG. 6 is a schematic view of the Cassegrain configuration for a reflector telescope, wherein the secondary optical output is optical communication with the auto-focusing system.

FIG. 7 is a schematic view of the Cassegrain configuration for a reflector telescope, wherein the secondary optical output is optical communication with both the auto-focusing and the auto-guiding system.

FIG. 8 is a schematic view of the Newtonian configuration for a reflector telescope, wherein the optically diverting feature is a hole through the redirecting mirror.

FIG. 9 is a schematic view of the Newtonian configuration for a reflector telescope, wherein the optically diverting feature is a hole through just the reflective surface of the redirecting mirror.

FIG. 10 is a schematic view of the Newtonian configuration for a reflector telescope, wherein the optically diverting feature is a wavelength-based beam splitting coating.

FIG. 11 is a schematic view of the Newtonian configuration for a reflector telescope, wherein the optically diverting feature is an energy-based beam splitting coating.

FIG. 12 is a schematic view of the Newtonian configuration for a reflector telescope, wherein the secondary optical output is optical communication with the auto-guiding system.

FIG. 13 is a schematic view of the Newtonian configuration for a reflector telescope, wherein the secondary optical output is optical communication with the auto-focusing system.

FIG. 14 is a schematic view of the Newtonian configuration for a reflector telescope, wherein the secondary optical output is optical communication with both the auto-focusing and the auto-guiding system.

### DETAILED DESCRIPTION OF THE INVENTION

All illustrations of the drawings are for the purpose of describing selected versions of the present invention and are not intended to limit the scope of the present invention.

The present invention is a configuration for a reflector telescope 1 that allows the reflector telescope 1 to make optical corrections such as guiding and focusing. The present invention comprises a reflector telescope 1 with a collecting mirror 2, a redirecting mirror 3, and a primary optical output 12. The reflector telescope 1 is made with two mirrors, which enables the reflector telescope 1 to reduce its physical length without having to reduce its focal length. The two mirrors are the collecting mirror 2 and the redirecting mirror 3. The collecting mirror 2 has a positive magnification power and is used to receive the incoming light for the reflector telescope 1. The redirecting mirror 3 has either a zero magnification power or a negative magnification power and is used to focus the incoming light towards the primary optical output 12. The primary optical output 12 can be, but is not limited to, a camera that is able to produce an image from the incoming light or an eyepiece that allows a user to view the image.

A main optical axis 14 of the reflector telescope 1 defines the path that the incoming light must travel through the reflector telescope 1. Thus, the main optical axis 14 traverses into the reflector telescope 1 towards the collecting mirror 2, traverses from the collecting mirror 2 to the redirecting mirror 3, and finally traverses from the redirecting mirror 3 to the primary optical output 12. The collecting mirror 2 and the redirecting mirror 3 are positioned offset from each other along the main optical axis 14 so that the incoming light travels a longer distance through the reflector telescope 1 in order to accommodate a longer focal length for the reflector telescope 1. This configuration allows the reflector telescope 1 to have a longer focal length. In addition, the path traveled by the main optical axis 14 through the reflector telescope 1 allows the collecting mirror 2 to be in optical communication with the primary optical output 12 by a reflective surface 3 of the redirecting mirror 3, which allows the primary optical output 12 to capture or render the incoming light.

The present invention further comprises a secondary optical output 15 in order to receive and analyze a portion of the incoming light that is used to make the optical corrections to the reflector telescope 1. However, in some embodiments of the present invention, the secondary optical output 15 could be an eyepiece that is used by the user to view the portion of the incoming light. Thus, the collecting mirror 2 needs to be in optical communication with the secondary optical output 15 through an optically diverting feature 5 of the redirecting mirror 3. The optically diverting feature 5 allows the redirecting mirror 3 to separate the portion of incoming light that is travelling towards the secondary optical output 15 without interfering with the remainder of incoming light that is travelling towards the primary optical output 12. In order to properly separate the incoming light between the primary optical output 12 and the secondary optical output 15, the redirecting mirror 3 is positioned in between the primary optical output 12 and the secondary optical output 15 so that the redirecting mirror 3 can divide the incoming light towards two distinct locations within the reflector telescope 1.

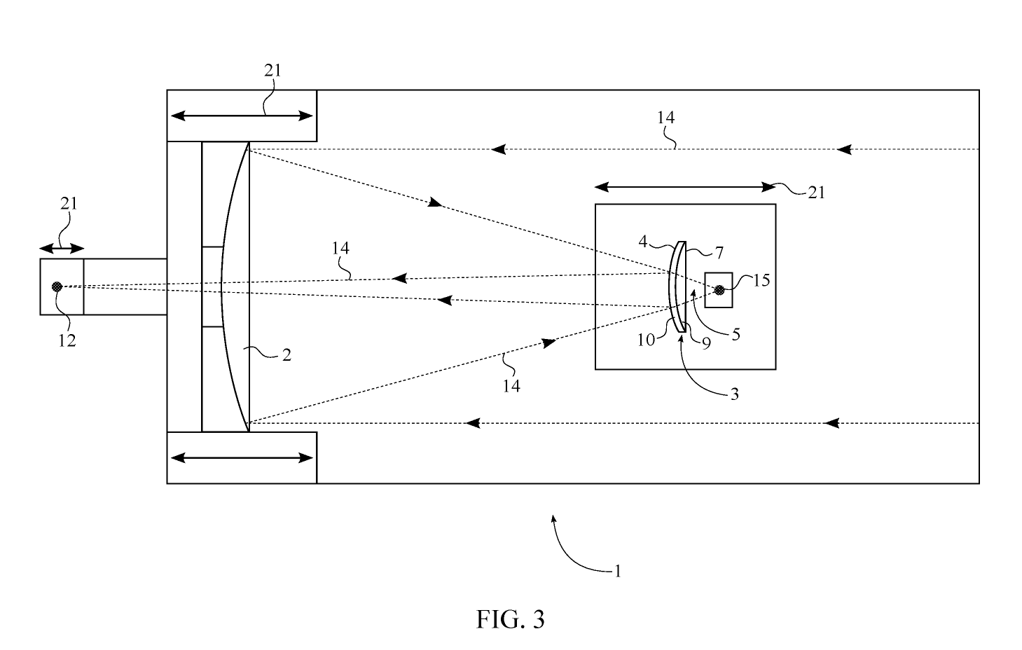

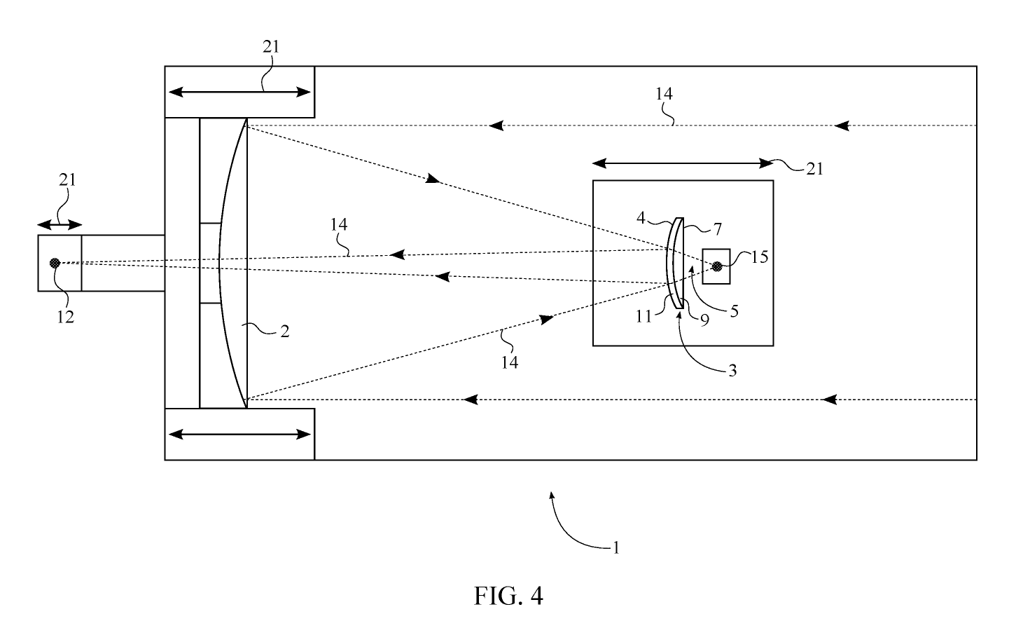

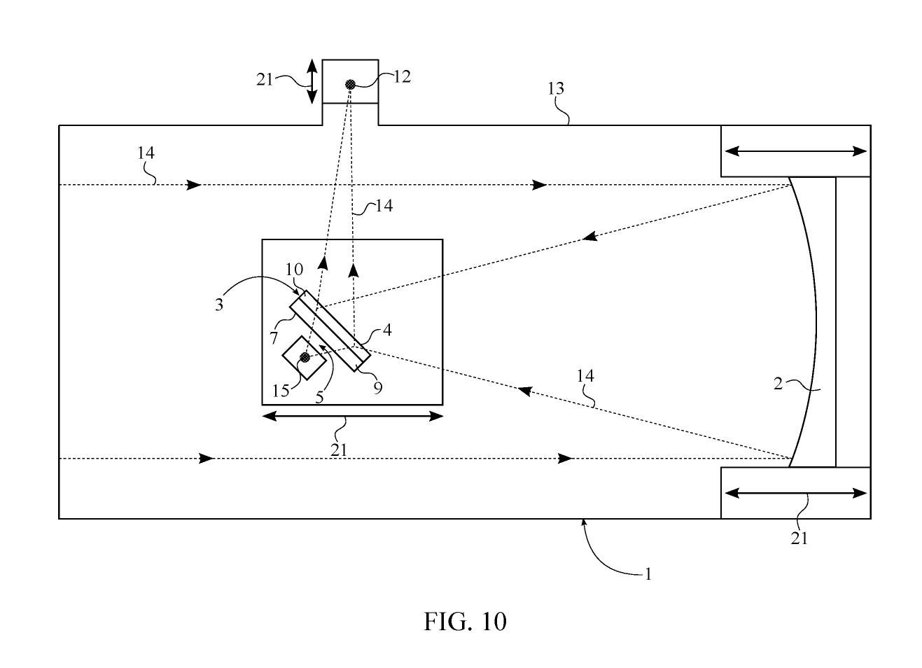

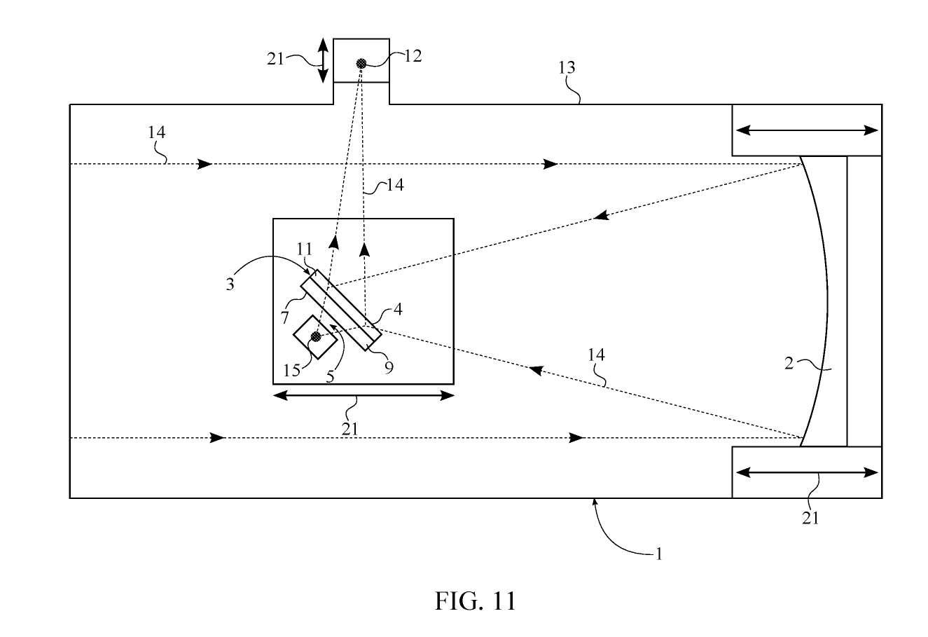

The reflective surface 3 and the optically diverting feature 5 can be configured into the redirecting mirror 3 through any of the following embodiments. In a first embodiment of the redirecting mirror 3 illustrated in FIGS. 3 and 10, a wavelength-based beam-splitting coating 10 is used to form the reflective surface 3 and the optically diverting feature 5 for the redirecting mirror 3. The wavelength-based beam-splitting coating 10 separates the incoming light into the portion travelling to the secondary optical output 15 and the remainder travelling to the primary optical output 12. For example, if the wavelength-based beam-splitting coating 10 is a dichroic filter, then the near infrared portion of the incoming light is directed towards the secondary optical output 15 and the visible portion of the incoming light is directed towards the primary optical output 12. In a second embodiment of the redirecting mirror 3 illustrated in FIGS. 4 and 11, an energy-based beam-splitting coating 11 is used to form the reflective surface 3 and the optically diverting feature 5 for the redirecting mirror 3. Similar to the wavelength-based beam-splitting coating 10, the energy-based beam-splitting coating 11 separates the incoming light into the portion travelling to the secondary optical output 15 and the remainder travelling to the primary optical output 12. For example, if the energy-based beam-splitting coating 11 is a standard optical filter, then a fraction of radiant energy from the incoming light is directed towards the secondary optical output 15 and the remainder of the radiant-energy from the incoming light is directed towards the primary optical output 12.

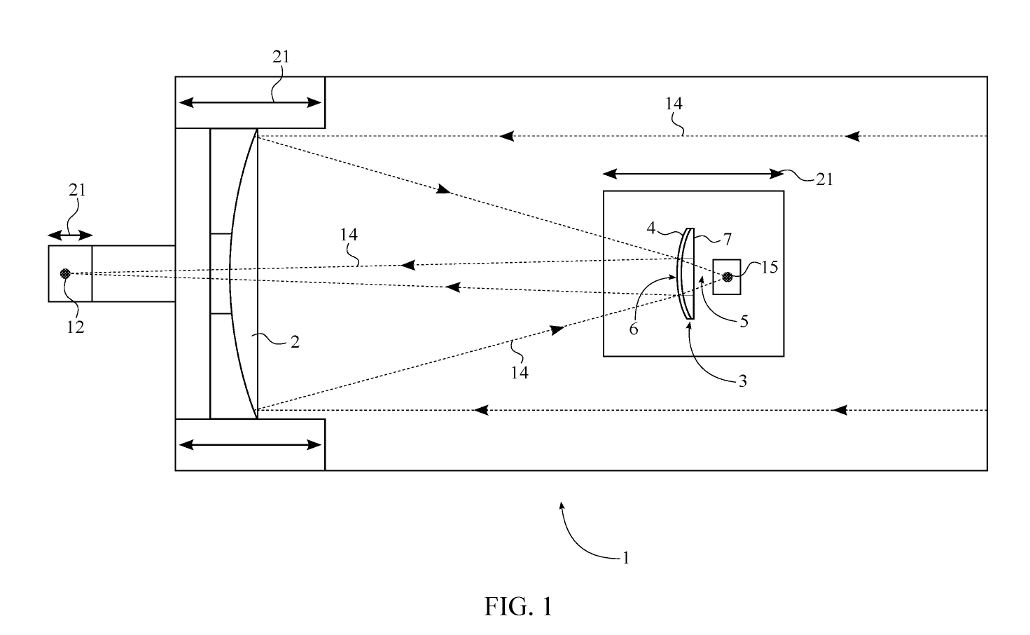

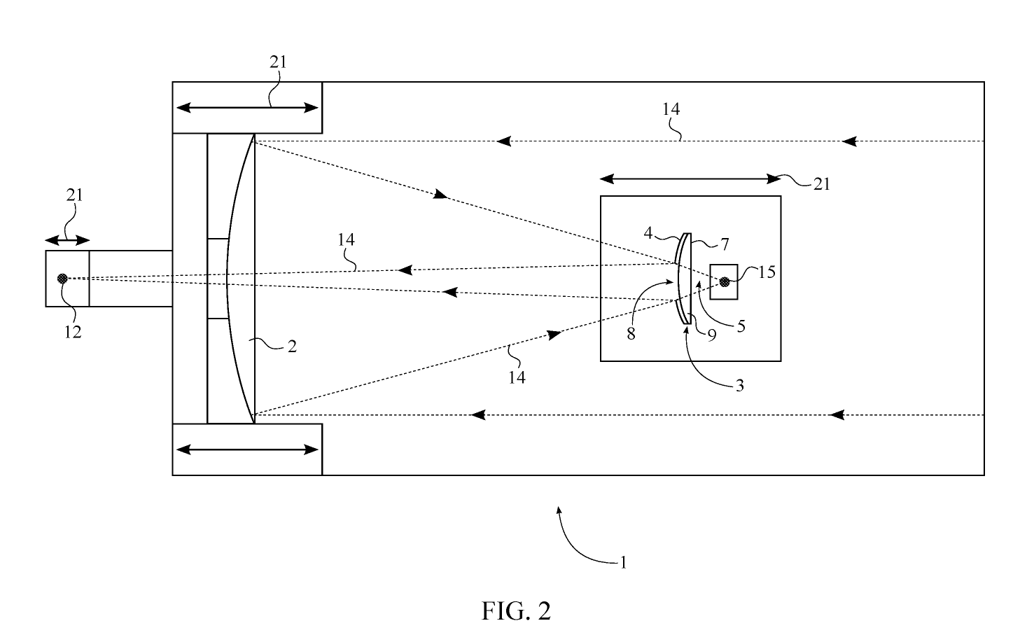

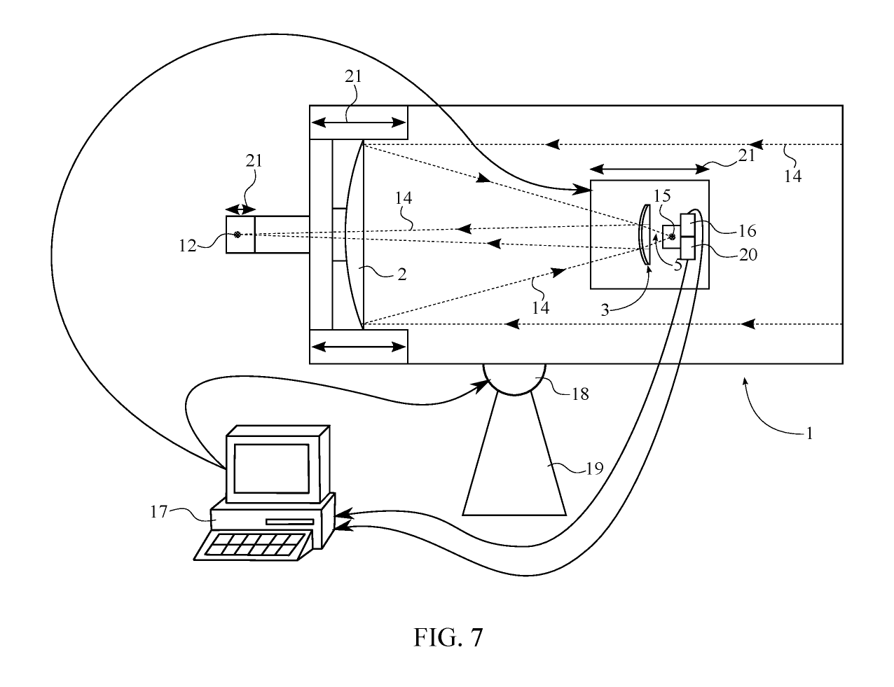

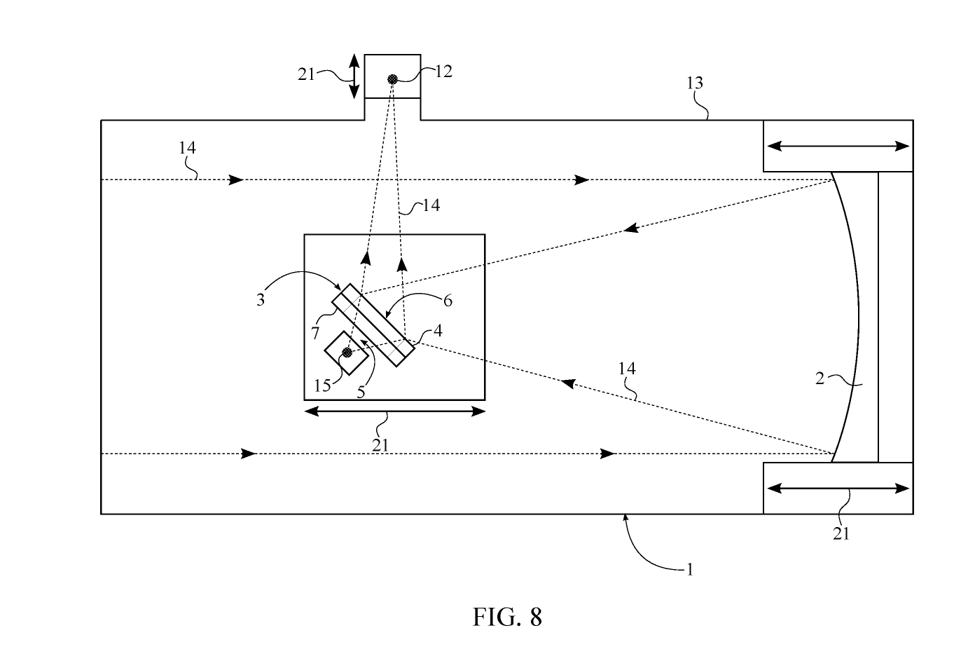

Instead of using a coating for the optically diverting feature 5, a physical hole can be used to direct the portion of the incoming light towards the secondary optical output 15. In a third embodiment of the redirecting mirror 3 illustrated in FIGS. 1 and 7, the optically diverting feature 5 is a hole 6 through the entire redirecting mirror 3 and traverses from its reflective surface 3 to an opposing surface 7 of the redirecting mirror 3. This allows the portion of incoming light that is directed towards the secondary optical output 15 to physically travel through the redirecting mirror 3. In a fourth embodiment of the redirecting mirror 3 illustrated in FIGS. 2 and 8, the optically diverting feature 5 is a hole 8 through the reflective surface 3 of the redirecting mirror 3. For this embodiment, the reflective surface 3 needs to be layered onto a transparent base 19 of the redirecting mirror 3 because the portion of incoming light that is directed towards the secondary optical output 15 will need to travel through the hole 8 in the reflective surface 3 and then travel through the transparent base 9 in order to reach the secondary optical output 15. The transparent base 9 can be, but is not limited to, glass or any other material with a refractive index near zero.

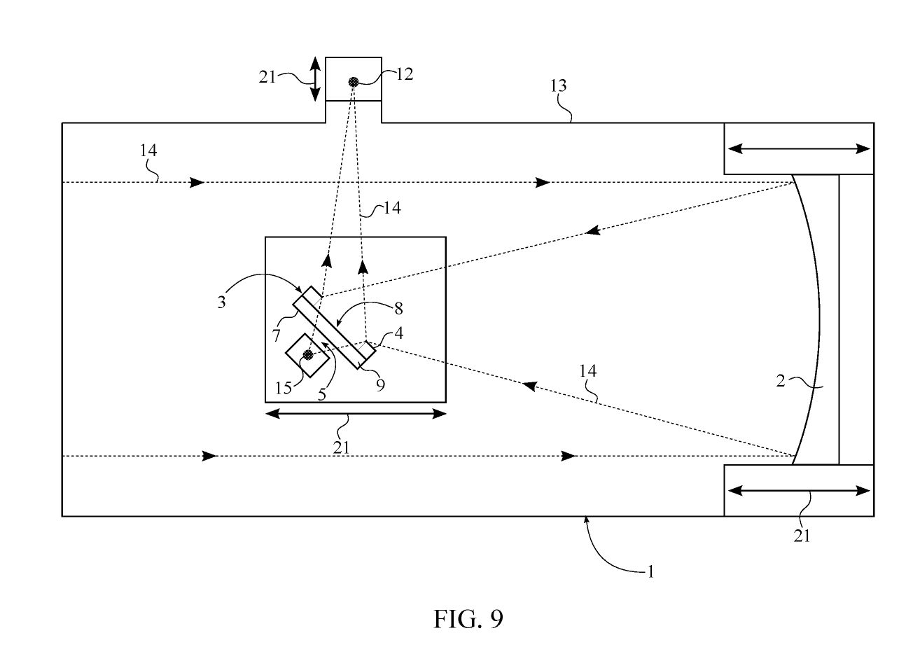

The two embodiments of the reflector telescope 1 that are best suited for the present invention are the Cassegrain-telescope configuration illustrated in FIG. 1 through 7 and the Newtonian-telescope configuration illustrated in FIG. 7 through 14. However, the other embodiments of the reflector telescope 1 can be used for the present invention as well. The Cassegrain-telescope configuration is when the components of the reflector telescope 1 are positioned in the following linear sequence along the reflector telescope 1: the secondary optical output 15, the redirecting mirror 3, the collecting mirror 2, and the primary optical output 12. For this configuration, the main optical axis 14 travels from the redirecting mirror 3 to the primary optical output 12 through an aperture in the collecting mirror 2 so that the incoming light is able to travel through the collecting mirror 2 in order to reach the primary optical output 12. Also for this configuration, the collective mirror has a positive magnification power, and the redirecting mirror 3 has a negative magnification power.

The Newtonian-telescope configuration is when the secondary optical output 15, the redirecting mirror 3, and the collecting mirror 2 are linearly sequenced in that order along the reflector telescope 1, while the primary optical output 12 is mounted laterally to the redirecting mirror 3. For this configuration, the main optical axis 14 travels from the redirecting mirror 3 to the primary optical output 12 in a direction that is perpendicular to the length of the reflector telescope 1 so that the incoming light is able to travel towards the primary optical output 12 located on the lateral portion 13 of the reflector telescope 2. Also in this configuration, the collecting mirror 2 has a positive magnification power, and the redirecting mirror 3 has a zero magnification power in order to direct the incoming light towards the primary optical output 12. The zero magnification power prevents the incoming light from becoming distorted once the incoming light reaches the primary optical output 12.

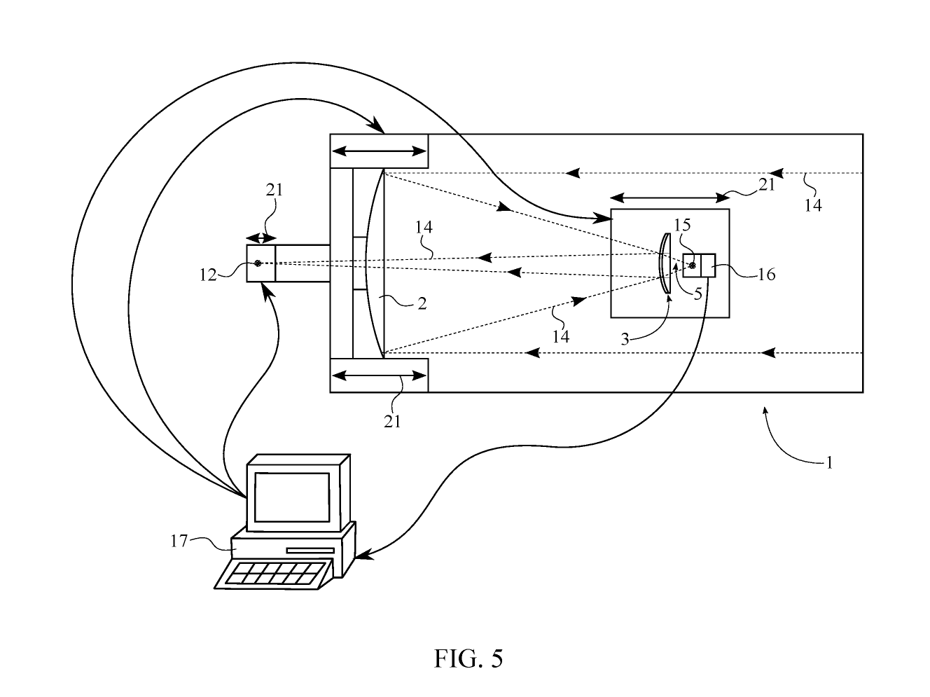

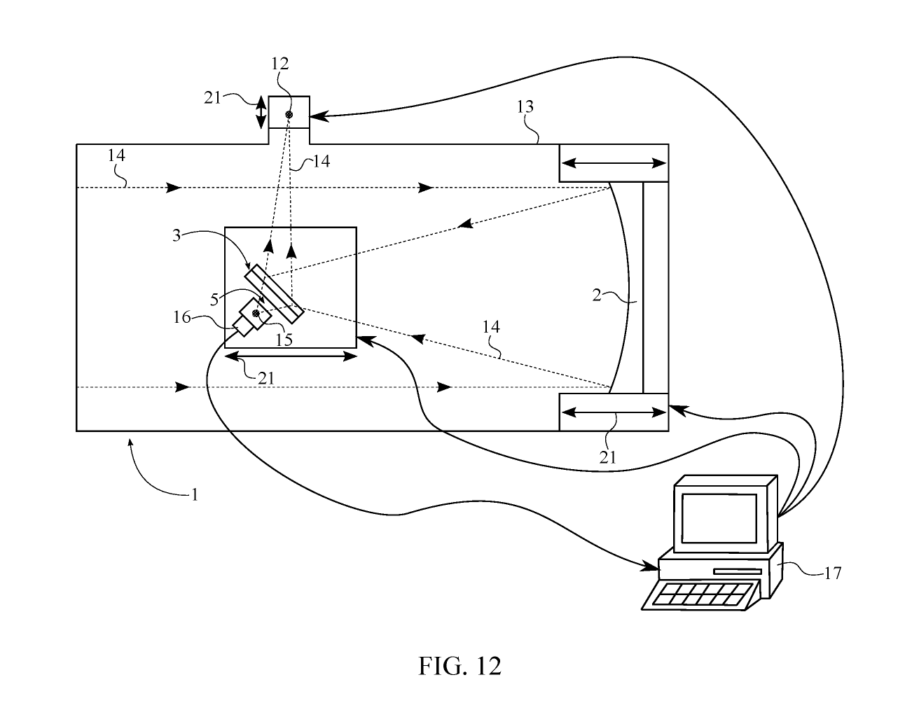

The present invention is designed to efficiently and effectively make optical corrections for the reflector telescope 1. Consequently, in some embodiments, the present invention further comprises an auto-guiding system 16 and/or an auto-focusing system 20. As can be seen in FIGS. 5 and 12, the auto-guiding system 16 is used to capture a current image of a reference object within the field of view (FOV) of the reflector telescope 1. The reference object can be, but is not limited to, a guide star or an artificially-created star. Thus, the secondary optical output 15 needs to be in optical communication with the auto-guiding system 16 so that the auto-guiding system 16 can capture the current image of the reference object from the secondary optical output 15. The auto-guiding system 16 is communicably coupled to a computing device 17 so that a computing device 17 can compare the current image of the reference object to a previously-captured image of the reference object in order to determine if the reference object had moved within the FOV. The computing device 17 will then generate a set of repositioning instructions to correct the orientation of the reflector telescope 1 in order to align the reference object at the same position in the FOV as in the previously-captured image. The computing device 17 is communicably coupled to an orientation mechanism 18 so that the computing device 17 can send the repositioning instructions to the orientation mechanism 18. The reflector telescope 1 is rotatably and pivotally mounted to the base 19 by the orientation mechanism 18, which allows the orientation mechanism 18 to execute the repositioning instructions sent by the computing device 17.

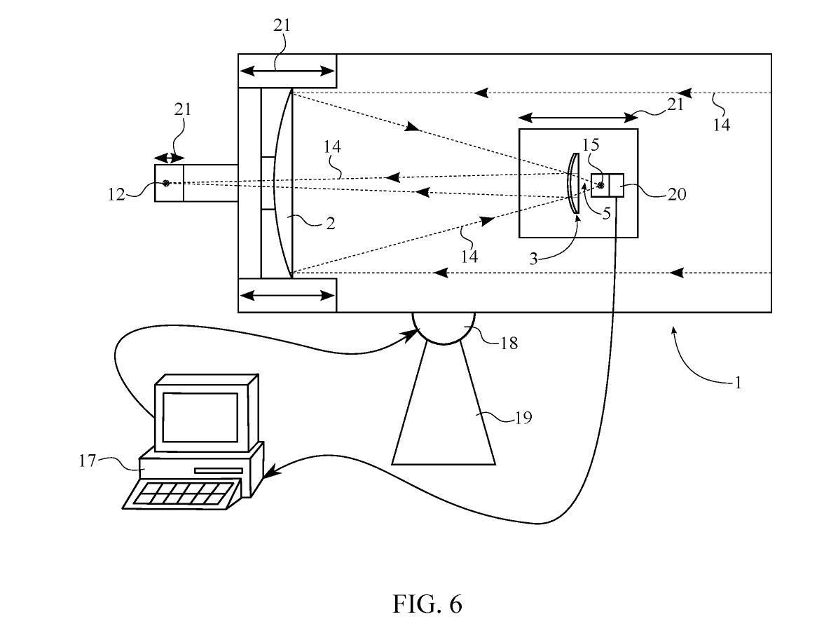

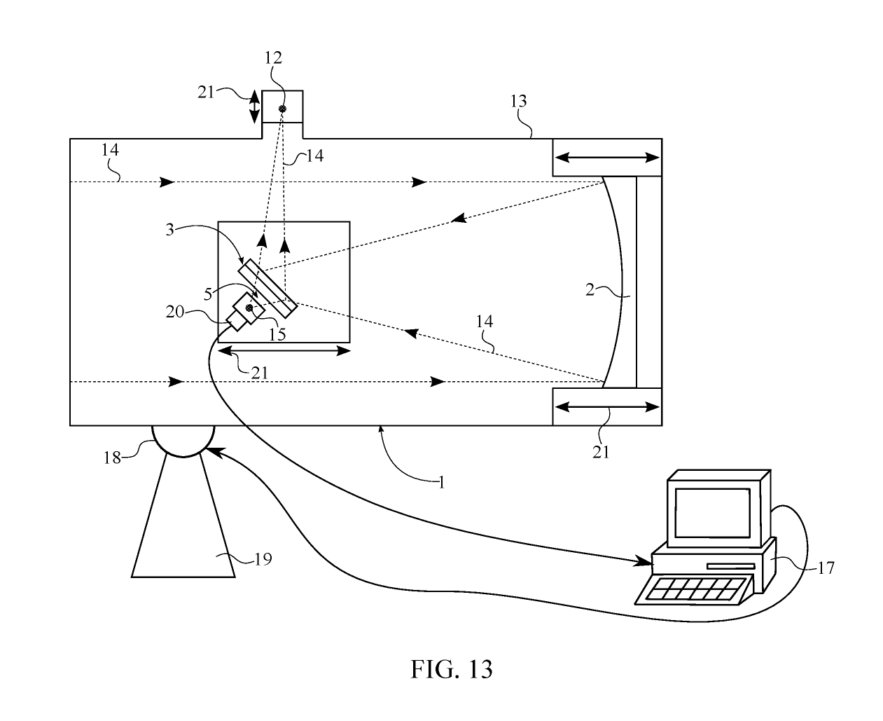

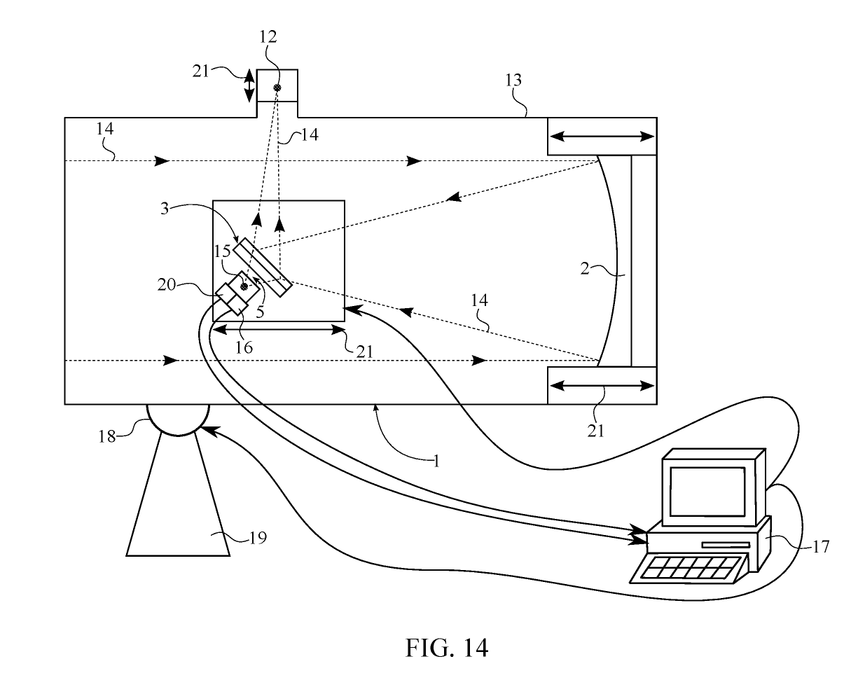

As can be seen in FIGS. 6 and 13, the auto-focusing system 20 is also used to capture a current image of a reference object through some kind of optical aberration. Thus, the secondary optical output 15 needs to be in optical communication with the auto-focusing system 20 so that the auto-focusing system 20 can capture the current image of the reference object from the secondary optical output 15. The auto-focusing system 20 is communicably coupled to a computing device 17 so that the computing device 17 can compare the optical aberrations in the current image to the optical aberrations in the previously-captured image in order to determine a defocused direction of the reflector telescope 1. The computing device 17 will then generate a set of realignment instructions to reduce the defocused direction of the reflector telescope 1. The computing device 17 is communicably coupled to an optical focusing mechanism 21 so that the computing device 17 can send the realignment instructions to the optical focusing mechanism 21. The optical focusing mechanism 21 is used to focus the primary optical output 12 and is operatively integrated into the reflector telescope 1, which allows the optical focusing mechanism 21 to execute the realignment instructions sent by the computing device 17. Moreover, the present invention can be configured to include the auto-guiding system 16, the auto-focusing system 20, or both the aforementioned systems, which is shown in FIGS. 7 and 14. In the scenario where both the auto-guiding system 16 and the auto-focusing system 20 are configured into the present invention, the auto-guiding system 16 and the auto-focusing system 20 are operatively integrated with each other because the current image of the reference object can be used to check if the FOV is in the same position as the previously-captured image and can be captured through some kind of optical aberration in order to measure the defocused direction.

In addition, the optical focusing mechanism 21 could be one of the following mechanical connections or a combination thereof. One mechanical connection that adjusts the focus of the reflector telescope 1 is to slidably mount the collecting mirror 2 along the main optical axis 14 within the reflector telescope 1, which allows the present invention to increase or decrease the focal length of the reflector telescope 1 and to adjust the focus of the reflector telescope 1. This mechanical connection is more efficient than the other mechanical connections because the optical focusing mechanism 21 only moves the collecting mirror 2 back and forth without affecting the path of the main optical axis 14. Another mechanical connection that adjusts the focus of the reflector telescope 1 is to slidably mount the redirecting mirror 3 along the main optical axis 14 within the reflector telescope 1, which allows the present invention to increase or decrease the focal length of the reflector telescope 1 and to adjust the focus of the reflector telescope 1. This mechanical connection is the easiest to implement from the other mechanical connections because the redirecting mirror 3 is relatively smaller in weight than the collecting mirror 2 and consequently is easier to move than the collecting mirror 2. However, the secondary optical output 15, the auto-guiding system 16, the auto-focusing system 20, or a combination thereof needs to move in unison with the redirecting mirror 3 in order to make the proper optical corrections to the reflector telescope 1. Another mechanical connection that adjusts the focus of the reflector telescope 1 is to slidably mount the primary optical output 12 along the main optical axis 14 adjacent to a lateral portion 13 of the reflector telescope 1, which allows a focal plane of the primary optical output 12 to be coincident to a sensing plane within an eye or an imager.

The following is a more detailed description of the auto-guiding system 16:
Imaging is a difficult proposition at best. Any deviation of less than a pixel during an exposure translates to errors as little as a “⅓ arc” with a long focal, leads to elongated stars.
In order to compensate for any motion and keep the image still during long exposures, a user typically implements a second camera to watch a guide star analysing its position relative to a reference guide star image, taken at the beginning of the imaging session.
A software application compares each new guide star frame with the reference one detecting any motion and sending corrections to the telescope mount, if any, to keep the guide star still. The guider acquisition rate is typically much faster than the imaging camera (imager). Guide star exposure times are in the range of few seconds to few minutes at most, while the imager exposure time of the target could be up to 30 minutes to one hour per frame.
If the imaging and guiding cameras have a solid and rigid mechanical and optical relationships, a still guide star means a still image of the target on the imaging camera as well.
Finding a bright enough guide star may become a challenging and time consuming task. Basically, there are several traditional options for guiding:
Guide-scope—The main advantage is a wide field of view (FOV) since most guide-scopes have short focal lengths. Therefore, the guide-scope almost guarantees to find a suitable guide star. However, guide-scopes are prone to differential flexures. The mechanical connection between both scopes must be very rigid. Otherwise, elongated stars will be viewed, and it does not take much. Guide-scopes may also add significant extra load to the mount.
Off-axis guider (OAG)—The OAG uses a pick-off prism placed in the vicinity of the imager, yet off-axis such it does not cast any shadow to your image. The resulting donut like FOV is quite narrow. Since OAGs use the same scope, there is neither differential flexure nor SCT mirror flop issues. However, they have a limited FOV to find a suitable guide star, higher F-numbers associated with small prisms, as well as possible extreme off-axis optical distortions (coma).
Self-guided cameras use a second CCD sensor located near the main one, yet on the same focal plane, such both sensors, the imager and the guider ones, reach both focus. This is like an OAG in a single body solution. Both self-guided camera and OAG may be extremely challenging to use with filters, especially narrow band ones, since those are placed before the guider sensor.
ON-Axis Guider (ONAG®—The ONAG splits the incoming light in two components with a dichroic beam splitter (DBS). The visible (typically from 370 nm-750 nm) is reflected toward the imager while the Near Infrared (NIR)(>750 nm) goes straight to the guider.
This design avoids any optical aberration for your images since it uses the reflected light, like a star diagonal does. Monochrome CCD/CMOS cameras are sensible in NIR and more than 76% of the main sequence stars have surface temperatures lower than 3700K radiating large amount of infrared energy. The ONAG® combines the advantages of the OAG, no flexure, with the wide FOV of a guide-scope. Since any filters will be placed in front of the imager, the guider is not affected by them, a great advantage for narrow band imaging. An integrated X/Y stage can provide an easy and fast way to find a guide star, resulting in a FOV>1.3 arc-degree for a 2-meter focal.
A user can also use a simple beam splitter (BS) instead of the dichroic mirror (DBS). In this case, all the wavelengths are seen by the imager and the guider cameras. However, only a fraction of the energy is received by each camera, such as the total is close to 100%.
For instance, the BS could split the incoming starlight in 50% for the imager and 50% for the guider (assuming no, or negligible loss in the BS), it also could be 80% for the imager and 20% for the guider, or any suitable combinations.
DBS and BS achieve fundamentally the same goal using the same scope (optics) for imaging and guiding, providing a wide FOV, on-axis and off-axis, which is known as ONAG technology.
   The following is a more detailed description of the auto-focusing system 20:
Focusing a telescope is a fundamental task for astro-photographic imaging. Maintaining best focus is crucial but over time load transfers due to the mount motion as well as changing temperature often cause a significant change in focus. Advanced scope designs, such as Ritchey-Chretien (RCT), are even more challenging on that matter. RCTs can deliver amazingly sharp images, but they exhibit significant astigmatism even inside the critical focus zone, therefore they must be at best focus all the time. A less known and subtle focus problem can be traced from temperature gradients inside mirrors, as well as different thermal inertias between secondary and primary mirrors. These types of issues are not easy to solve leading eventually to recurrent refocus interruptions. Imaging software packages typically allow for periodic refocusing. The classical procedure calls for slewing the scope toward a bright enough reference star, then running an autofocus (AF) utility, such as a V-curve focusing algorithm, and finally reacquiring the target. This is, at best, a time consuming procedure during which we are no longer imaging your target. It can also result in additional problems if the mount is unsuccessful at accurately reacquiring the target after the focus routine. As a general rule, every time the target moves away, precious imaging time is not only lost, but other problems can occur. It is quite common to find that the first frames after the target reacquisition have a poor Full Width at Half Maximum profile (FWHM) due to the mechanical settling time linked to the focus slewing. The solution describes in the patent application entitled “Closed-Loop System for Auto-Focusing in Photography and a Method of Use Thereof” (U.S. Ser. No. 14/470,935) provides a better and unique way to deal with focus changes using a true Real Time Auto Focus (RTAF) solution. U.S. Ser. No. 14/470,935 continually monitors and maintains critical focus without any interruptions in imaging operations. There is no longer any need to slew the scope to focus stars to stay in focus.
   The following is a more detailed description of the auto-focusing system 16 and the auto-focusing system 20:
Recognizing that high performance astrographs and large CCD chips require an even more accurate focus, we have developed a new solution for providing real time autofocus (RTAF) operation while guiding with an ONAG® device. This breakthrough technology provides RTAF using the guide star during normal imaging of the target object.
Any RTAF system needs information not only about the quality of the focus (such as FWHM or HFD, Half Flux Diameter) but also in which direction the focuser mechanism should move to achieve focus. Unlike conventional AF software, the advanced algorithms used in U.S. Ser. No. 14/470,935 analyze each guide star image as it comes in, as well as their past history, evaluating focus quality, and deterring the required focus correction without actually having to move the focuser.
When a focus correction is required, if any, the controller computes the necessary focuser motion (how many steps and in which direction) and provides real time auto-focus capability.
SL keeps the optical system at best focus every time, all the time, efficiently integrating two crucial tasks for astrophotography: guiding and focusing.
The auto-guiding and, therefore, RTAF rate is typically between 1 to 120 seconds depending on the guide exposure settings. AF corrections at such rates are very small (a few microns), and the required focus correction does not impact image quality. In fact, any movement caused by the focus correction should be corrected by the auto-guiding function before it becomes visible.

It should be understand for anybody skills in the engineering and optical design art, that variants of the above disclosed ideas could be considered, or combined, and implemented to eventually reach the same capabilities (auto-guiding and/or RTAF, and/or AO), as well as to improve the design and lower the cost using the telescope M2, if necessary, in combination of M1 and/or mechanical focusers for the imager and/or guider cameras. Finally, any of the focusers could be made without moving the cameras and related accessories, such as filter wheel, etc. The focusing functionality can be made with optical moving parts, such as lenses (spherical or as-spherical, or deformable lens(es)) and auxiliary mirror(s). Image scale changes, if any, can be compensated for by image processing. It is understood that a combination of motion of camera(s) and optical element(s) is also an option.

Although the invention has been explained in relation to its preferred embodiment, it is to be understood that many other possible modifications and variations can be made without departing from the spirit and scope of the invention as hereinafter claimed.

What is claimed is:

1. An optically correcting configuration for a reflector telescope comprises:
a reflector telescope;
a secondary optical output;
said reflector telescope comprises a collecting mirror, a redirecting mirror, and a primary optical output;
a main optical axis of said reflector telescope traversing into said reflector telescope towards said collecting mirror, from said collecting mirror to said redirecting mirror, and from said redirecting mirror to said primary optical output;
said collecting mirror and said redirecting mirror being positioned offset from each other along said main optical axis;
said collecting mirror being in optical communication with said primary optical output by a reflective surface of said redirecting mirror;
said collecting mirror being in optical communication with said secondary optical output through an optically diverting feature of said redirecting mirror; and
said redirecting mirror being positioned in between said primary optical output and said secondary optical output.

2. The optically correcting configuration for a reflector telescope as claimed in claim 1, wherein said collecting mirror and said redirecting mirror are arranged in a Cassegrain-telescope configuration within said reflector telescope.

3. The optically correcting configuration for a reflector telescope as claimed in claim 1, wherein said collecting mirror and said redirecting mirror are arranged in a Newtonian-telescope configuration within said reflector telescope.

4. The optically correcting configuration for a reflector telescope as claimed in claim 1 comprises:
said collecting mirror being slidably mounted along said main optical axis, within said reflector telescope.

5. The optically correcting configuration for a reflector telescope as claimed in claim 1 comprises:
said redirecting mirror being slidably mounted along said main optical axis, within said reflector telescope.

6. The optically correcting configuration for a reflector telescope as claimed in claim 1 comprises:
said primary optical output being slidably mounted along said main optical axis, adjacent to a lateral portion of said reflector telescope.

7. The optically correcting configuration for a reflector telescope as claimed in claim 1, wherein a wavelength-based beam-splitting coating forms said reflective surface and said optically diverting feature of said redirecting mirror.

8. The optically correcting configuration for a reflector telescope as claimed in claim 1, wherein an energy-based beam-splitting coating forms said reflective surface and said optically diverting feature of said redirecting mirror.

9. The optically correcting configuration for a reflector telescope as claimed in claim 1 comprises:
said optically diverting feature being a hole through said redirecting mirror; and
said hole being traversing from said reflective surface to an opposing surface of said redirecting mirror.

10. The optically correcting configuration for a reflector telescope as claimed in claim 1 comprises:
said optical diverting feature being a hole through said reflective surface; and
said reflective surface being layered onto a transparent base of said redirecting mirror.

11. The optically correcting configuration for a reflector telescope as claimed in claim 1 comprises:
an auto-guiding system;
a computing device;
an orientation mechanism;
a base;
said secondary optical output being in optical communication with said auto-guiding system;
said auto-guiding system being communicably coupled to said computing device;
said computing device being communicably coupled to said orientation mechanism; and
said reflector telescope being rotatably and pivotally mounted to said base by said orientation mechanism.

12. The optically correcting configuration for a reflector telescope as claimed in claim 11 comprises:
an auto-focusing system;
an optical focusing mechanism;
said auto-focusing system being operatively integrated into said auto-guiding system;
said computing device being communicably coupled to said optical focusing mechanism; and
said optical focusing mechanism being operatively integrated into said reflector telescope, wherein said optical focusing mechanism is used to focus said primary optical output.

13. The optically correcting configuration for a reflector telescope as claimed in claim 1 comprises:
an auto-focusing system;
a computing device;
an optical focusing mechanism;
said secondary optical output being in optical communication with said auto-focusing system;
said auto-focusing system being communicably coupled to said computing device;
said computing device being communicably coupled to said optical focusing mechanism; and
said optical focusing mechanism being operatively integrated into said reflector telescope, wherein said optical focusing mechanism is used to focus said primary optical output.

14. The optically correcting configuration for a reflector telescope as claimed in claim 13 comprises:
an auto-guiding system;
an orientation mechanism;
a base;
said auto-guiding system being operatively integrated into said auto-focusing system;
said computing device being communicably coupled to said orientation mechanism; and
said reflector telescope being rotatably and pivotally mounted to said base by said orientation mechanism.
